(19) United States
(12) Patent Application Publication
(10) Pub. No.: US 2020/0200320 A1
(43) Pub. Date: Jun. 25, 2020

(54) Device for connecting a supported member to a support

(71) Applicant: Glen Dale Seekins, Lewiston, ID (US)

(72) Inventor: Glen Dale Seekins, Lewiston, ID (US)

(73) Assignee: Seekins Precision, LLC, Lewiston, ID (US)

(21) Appl. No.: 16/724,012

(22) Filed: Dec. 20, 2019

Related U.S. Application Data
(60) Provisional application No. 62/782,958, filed on Dec. 20, 2018.

(51) Int. Cl. F16M 11/04; F16B 2/04

(52) U.S. Cl. CPC F16M 11/041; G03B 17/561; F16B 2/04

(57) ABSTRACT

An attachment apparatus permitting a supported member to move laterally relative to a support and containing features which prevent the supported member from laterally relative to a support when engaged. The apparatus is further configured to be clamped to the support as an additional or alternative means of attachment.

### CROSS-REFERENCE TO RELATED APPLICATIONS

This application claims priority to provisional application 62/782,958 fled on Dec. 20, 2018.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

Not Applicable

STATEMENT REGARDING PRIOR DISCLOSURES BY AN INVENTOR OR JOINT INVENTOR

Not Applicable

### BACKGROUND OF THE INVENTION

A variety of disciplines favor devices be stabilized in certain circumstances and be freely movable in other circumstances. Among these disciplines are photography, videography, and sport shooting. For photography, if the camera is moving during exposure, the resulting photograph may be blurry. At other times, a photographer may need to move the camera do a different position to make it possible to capture a particular photo. For videography, if the video camera is moving during recording, the resulting video may be blurry or unpleasant to watch. At other times, a videographer may wish to place a video camera on a different support, or a different video camera on a particular support. At other times, a videographer may intentionally move the camera while recording to achieve certain effects. For sport shooting, if the firearm is moving during the shooting process, the target may be lost from view or the shooter may miss the target. At other times, a shooter may want or need to detach the firearm from the support to move to a different location without the support.

A variety of quick-attach/quick-detatch systems have been developed to address the need for a secure attachment system which also can be quickly attached and detatched.

### DESCRIPTION OF RELATED ART INCLUDING INFORMATION DISCLOSED UNDER 37 CFR 1.97 AND 37 CFR 1.98.

Not Applicable

### BRIEF SUMMARY OF THE INVENTION

An attachment apparatus permitting a supported member to move laterally relative to a support and containing features which prevent the supported member from laterally relative to a support when engaged. The apparatus is further configured to be clamped to the support as an additional or alternative means of attachment.

### BRIEF DESCRIPTION OF THE SEVERAL VIEWS OF THE DRAWING

FIG. 1 shows a top exploded perspective view of the clamping device of the present invention.

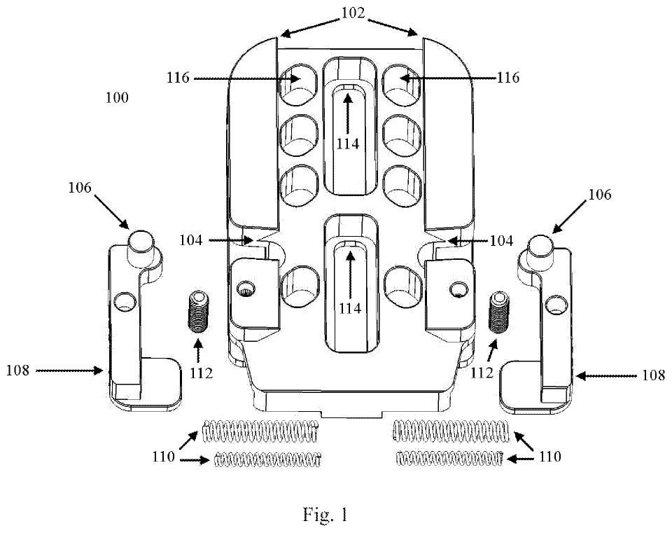

FIG. 2 shows a bottom exploded perspective view of the clamp device of the present invention.

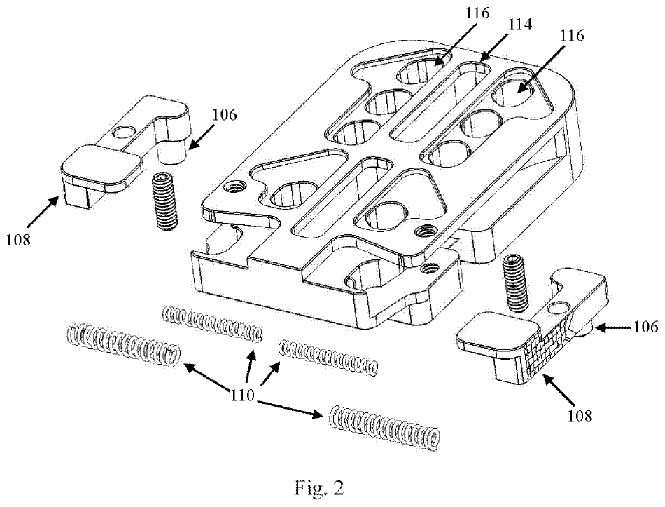

FIG. 3 show a top side perspective view of the clamp device of the present invention.

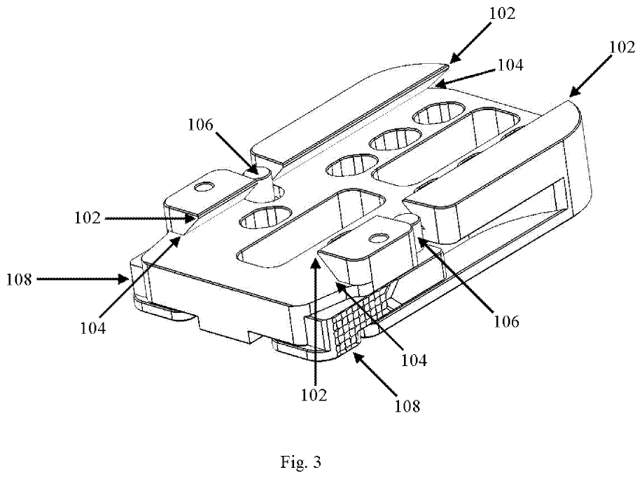

FIG. 4 shows an end view of the clamp device of the present invention with the interference features in an interfering position.

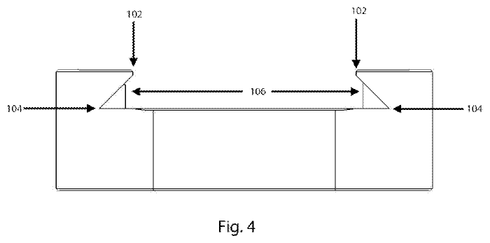

FIG. 5 shows an end view of the clamp device of the present invention with the interference features in a non-interfering position.

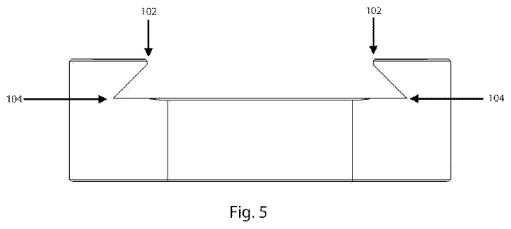

FIG. 6 shows a bottom orthogonal view of an accessory rail of the present invention.

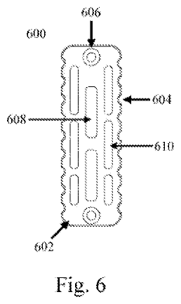

FIG. 7 shows a side orthogonal view of an accessory rail of the present invention.

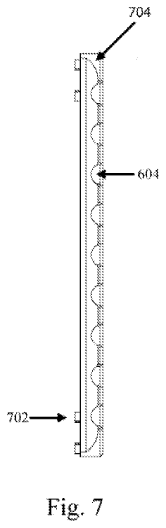

FIG. 8 shows an end orthogonal view of an accessory rail of the present invention.

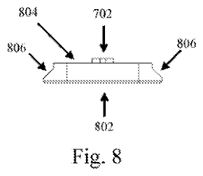

### DETAILED DESCRIPTION OF THE INVENTION

Accessory Rail

The applicant's invention comprises an accessory rail 600 configured to be attached to a both a device and a support and/or support adapter. The rail consists of a body 602 having a number of features. The rail may be attached to the device through any of various means. The rail may be integral to the device or detachable. In a preferred embodiment, the rail is detachable, connecting to the device using a mounting standard. An exemplary, non-exclusive, list of mounting standards includes a ⅜ inch 16 UNC threaded hole, ¼-20 UNC thread threaded hole, M-LOK features 608, Key-Mod, and Picatinny rail. In certain embodiments, the accessory rail is configured with a plurality of alignment features 702 configured to aid in aligning the accessory rail to a device to which it is attached. Other mounting standards, presently know or hereafter created, may be used to connect the detachable rail to a device without deviating from the present invention.

In a preferred embodiment, the accessory rail has a cross section which is shaped generally like an isosceles trapezoid having a lower base 802 longer than a top base 804 and sloped sides 806. In a preferred embodiment, the accessory rail is configured to be slid laterally through a clamp connector. In a preferred embodiment, the accessory rail is configured with radiused 704 or tapered ends configured to automatically displace interference features of a clamp when the rail is slid through the opening of a clamp connector. Alternatively, or simultaneously, the accessory rail is configured to drop into an opened clamp connector when the clamp connector is opened such that the opening at its narrowest is wider than the accessory rail at its widest.

In a preferred embodiment, the accessory rail is configured with a plurality of features configured to interact with features 604 of a clamp connector such that, when engaged, the accessory rail resists lateral movement within the clamp connector. In a preferred embodiment, the features are one or more depressions in at least a portion of the side(s) of the accessory rail.

In a preferred embodiment, when the accessory rail is not integral to the device, the accessory rail is configured with a plurality of openings 610 configured to align with openings in a device to which the accessory rail is attached. The openings allow air to flow through openings in the accessory rail and in the device to which the accessory rail is attached substantially unencumbered regardless of whether the accessory rail is attached to the device.

In a preferred embodiment, the accessory rail is configured with features conforming to a mounting standard which allows accessories to be mounted to the accessory rail. An exemplary, non-exclusive, list of mounting standards includes a ⅜ inch 16 UNC threaded hole, ¼-20 UNC thread threaded hole, QD hole 606, M-LOK features, Key-Mod, and Picatinny rail.

Clamp connector

The applicant's invention further comprises a clamp connector 100. In a preferred embodiment, the clamp connector comprises an opening which is shaped generally like an isosceles trapezoid having a lower base 104 longer than a top base 102. In a preferred embodiment, the length of the top opening 102 of the clamp is less than the length of the bottom base 802 of the accessory rail 600 such that the accessory rail 600 cannot be vertically withdrawn from the clamp connector. In a preferred embodiment, the dimensions of the opening of the clamp connector 100 is slightly larger than the dimensions of a cross-section of the accessory rail 600 such that the accessory rail may slide through clamp connector 100 relatively unencumbered and without excessive play. In a preferred embodiment, the materials from which the clamp connector 100 and the accessory rail 600 are made, and or coatings applied to the surfaces which interface, are selected to achieve the desired degree of lubricity between the surfaces.

In a preferred embodiment, the clamp connector 100 is configured with features conforming to a mounting standard by which the clamp connector 100 may be connected to a support. An exemplary, non-exclusive, list of mounting standards includes a ⅜ inch 16 UNC threaded hole, ¼-20 UNC thread threaded hole, QD hole, M-LOK features 114, Key-Mod, and Picatinny rail. In a preferred embodiment, the clamp connector 100 is further configured with a plurality of holes 116 through which air may pass to aid in cooling an apparatus connected using the system.

In a preferred embodiment, the clamp connector 100 is configured with interference features 106 which, when engaged, resist lateral movement of the accessory rail 600 relative to the clamp connector 100. In a preferred embodiment, the interference features 106 are projections which cooperatively couple with depressions 604 in the side(s) of an accessory rail 600. When engaged, the interference features of the clamp connector 100 mechanically prevent the removal and/or movement of the accessory rail 600 within the clamp connector 100. When disengaged, the interference features 106 of the clamp connector 100 mechanically do not prevent the removal and/or movement of the accessory rail 600 within the clamp connector 100.

In an alternative embodiment, the features comprise a means for reducing the width of the clamping apparatus opening to create a friction fit between the clamp connector 100 and the accessory rail 600 preventing the removal and/or movement of the accessory rail 600 within the clamp connector 100.

In a preferred embodiment, the interference features 106 of the clamp connector 100 are biased toward engagement (interfering with features of the accessory rail) using force-applying features such as springs 110. In this embodiment, in a preferred embodiment, the clamp connector is configured with activation features 108 which enable a user to overcome the bias and disengage the interference features 106 (move the features 106 to a position which does not interfere with features 604 of the accessory rail 600). The interference features 106 and activation features 108 are movebly attached 112 to the clamp connector 100. In an alternative embodiment, the interference features 106 of the clamp connector 100 are biased toward not interfering with features 604 of the accessory rail 600. In this embodiment, the clamp connector 100 is configured with activation features which enable a user to overcome the bias and move the features to a position which interferes with features of the accessory rail and remain in that position without the continued application of force by the user.

In a preferred embodiment, the activation features 108 are positioned to enable a user to activate any and all activation features 108 necessary to insert and remove the accessory rail 600 from the clamp connector 100 with one hand.

When the clamp connector 100 is biased toward interfering with features 604 of the accessory rail 600, in a preferred embodiment, the accessory rail 600 is configured with features which temporarily overcome the bias when the accessory rail 600 is inserted into the clamp connector 100. In a preferred embodiment, the features which temporarily overcome the bias are a tapered and/or beveled leading and/or trailing edge 704 which enable the accessory rail 600 to be slid into the clamp connector 100 from at least one end of the accessory rail 600 without requiring the user to manually deactivate the interference features 106 other than by inserting the accessory rail 600.

The clamp connector 100 and accessory rail 600 of the present invention may be used in an inverted orientation without deviating from the present invention. Specifically, the clamp connector 100 may be attached to a device, and the accessory rail 600 may be attached to the support, within the scope of the present invention.

1. An accessory body configured to selectively attach a device to a support comprising:
A) an accessory body member having a cross section which is narrower at some point configured to be installed adjacent a device than at some point configured to be installed adjacent a support, and
B) said accessory body member is configured with a plurality of depressions in one or more sides of said accessory body member configured to interface with a support attchment.

2. The accessory body of claim 1 further comprising:
A) means for attaching said accessory body member to an accessory.

3. The accessory body of claim 2 wherein:
A) said attachment means are integral to a device.

4. The accessory body of claim 2 wherein:
A) said attachment means conform to a mounting standard and said accessory body member are detachable from a device.

5. The accessory body of claim 2 wherein:
A) one or more edges of said said accessory body have a thickness which is less near an end than near the center, configured to disengage interference features of a clamp connector.

6. The accessory body of claim 5 wherein said accessory body further comprises:
A) a plurality of alignment features which physically align said accessory body with a device to which it is attached.

7. The accessory body of claim 6 wherein said accessory body further comprises:
A) a plurality of holes passing through the thickness of said accessory body configured to permit the passage of air through said accessory body.

8. A clamp connector configured to selectively attach a support to an accessory body comprising:
A) a clamp connector body member having a channel, open at both ends, with sides which are narrower at some point configured to be installed adjacent a device than at some point configured to be installed adjacent a support,
B) a plurality of interference features configured to enter said sides of said channel of said clamp connector body member,
C) a plurality of interference feature biasing elements configured to maintain the position of interference features, and
D) a plurality of interference feature activation elements configured to allow a user to overcome interference feature biasing and displace interference features.

9. The clamp connector of claim 8 wherein:
A) said sides of said clamp connector body are substantially immovable.

10. The clamp connector of claim 9 further comprising:
A) means for attaching said clamp connector body to a support.

11. The clamp connector of claim 10 wherein:
A) said means for attaching said clamp connector body to a support are integral to a support.

12. The clamp connector of claim 10 wherein:
A) said means for attaching said clamp connector body to a support are detachable from a support.

13. The clamp connector of claim 8 wherein:
A) said interference feature biasing elements bias said interference features toward interfering with an accessory body installed in said clamp connector body.

14. The clamp connector of claim 13 wherein said clamp connector body further comprises:
A) a plurality of holes passing through the thickness of said clamp connector body configured to permit the passage of air through said clamp connector body.

15. An accessory attachment system comprising:
A) an accessory body member wherein:
I) said accessory body member has a cross section which is narrower at some point configured to be installed adjacent a device than at a surface configured to be installed adjacent a support, and
II) said accessory body member is configured with a plurality of depressions in one or more sides of said accessory body member configured to interface with a clamp connector; and
B) a clamp connector configured to selectively attach a support to an accessory body comprising:
I) a clamp connector body member having a channel, open at both ends, with sides which are narrower at some point configured to be installed adjacent a device than at some point configured to be installed adjacent a support,
II) interference features configured to enter said sides of said channel of said clamp connector body member,
III) interference feature biasing elements configured to maintain the position of interference features, and
IV) interference feature activation elements configured to allow a user to overcome interference feature biasing and displace interference features.

16. The accessory attachment system of claim 15 wherein:
A) said sides of said clamp connector body are substantially immovable.

17. The accessory attachment system of claim 16 wherein:
A) one or more edges of said said accessory body have a thickness which is less near an end than near the center, configured to disengage interference features of a clamp connector, and
B) said interference feature biasing elements of said clamp connector bias said interference features toward interfering with an accessory body installed in said clamp connector body.

18. The accessory attachment system of claim 17 wherein:
A) said accessory body further comprises a plurality of holes passing through the thickness of said accessory body configured to permit the passage of air through said accessory body,
B) said clamp connector body further comprises a plurality of holes passing through the thickness of said clamp connector body configured to permit the passage of air through said clamp connector body, and
C) said a plurality of holes passing through the thickness of said accessory body configured to permit the passage of air through said accessory body and plurality of holes passing through the thickness of said clamp connector body are configured to align.
